(19) United States
(12) Patent Application Publication
(10) Pub. No.: US 2014/0213184 A1
(43) Pub. Date: Jul. 31, 2014

(54) INTRA-BODY COMMUNICATION APPARATUS PROVIDED WITH MAGNETIC INDUCTION WIRELESS COMMUNICATION CIRCUIT PERFORMING WIRELESS COMMUNICATIONS USING MAGNETIC INDUCTION

(71) Applicant: PANASONIC HEALTHCARE CO., LTD., Ehime (JP)

(72) Inventor: Naoki MATSUBARA, Tokyo (JP)

(73) Assignee: PANASONIC HEALTHCARE CO., LTD., Ehime (JP)

(21) Appl. No.: 14/229,231

(22) Filed: Mar. 28, 2014

Related U.S. Application Data
(63) Continuation of application No. PCT/JP2013/004811, filed on Aug. 9, 2013.

(30) Foreign Application Priority Data
Aug. 24, 2012 (JP) 2012-184819

(51) Int. Cl. H04B 5/00

(52) U.S. Cl. CPC H04B 5/0081; H04B 5/0031
USPC 455/41.1

(57) ABSTRACT

An intra-body communication apparatus includes an antenna coil configured to wirelessly communicate a magnetic induction signal with communication equipment by using magnetic induction at a carrier frequency, an electrode for a human body, the electrode connected to the antenna coil, and a resonance circuit including the antenna coil. The resonance circuit resonates at the carrier frequency. The intra-body communication apparatus is configured to transmit the magnetic induction signal from the communication equipment received by the antenna coil to the human body via the resonance circuit at the carrier frequency, without converting or changing a frequency of the magnetic induction signal.

### CROSS-REFERENCE TO RELATED APPLICATIONS

This is a continuation application based on PCT application No. PCT/JP 2013/004811 filed on Aug. 9, 2013, which claims priority to Japanese patent application No. JP 2012-184819 filed Aug. 24, 2012, the entire contents of each of which are incorporated herein by reference.

### BACKGROUND OF THE DISCLOSURE

The present disclosure relates to an intra-body communication apparatus that utilizes intra-body communications and communication equipment, in a short-distance wireless communication technology using magnetic induction.

In recent years, bi-directional communications between communication equipment adopting a short-distance wireless communication technology using magnetic induction, as represented by the NFC (Near Field Communication) standard, have attracted attention.

The communications using magnetic induction has such an advantage that data can be simply exchanged only by bringing communication devices close to each other. However, a communication distances is about several centimeters to 10 cm, and there is a problem that communications become impossible when the relative positional relation between antenna coils mounted on each communication device is shifted. With respect to the communications using magnetic induction, technologies using booster antenna coils and a human body as a transmission medium have been proposed as means for extending the communication distance (See, for example, a Patent Document 1 of Japanese patent laid-open publication No. JP 2009-81771 A).

FIG. 10 is a block diagram showing an example of a configuration of a prior art intra-body communication system disclosed in, for example, FIG. 1 of Patent Document 1. This communication system includes a reader-writer 11 for non-contact IC card communications, a communication terminal apparatus 12, a communication terminal apparatus 13, a non-contact IC card 14, and the human body 15 of a user. For example, in the communication system, the reader-writer 11 and the communication terminal apparatus 12 are arranged to be fixed to predetermined positions, and the communication terminal apparatus 13 and the non-contact IC card 14 are held by the human body 15 of the user.

The reader-writer 11 includes a loop antenna 21 for performing wireless communications in a non-contact manner. The reader-writer 11 generates a magnetic field by flowing a current through the loop antenna 21 and transmits and receives signals for non-contact IC card communications with the communication terminal apparatus 12. The communication terminal apparatus 12 performs non-contact IC card communications with the reader-writer 11, and performs intra-body communications with the communication terminal apparatus 13 using the human body 15 as a communication medium. The communication terminal apparatus 12 includes a loop antenna 22 for performing wireless communications, a non-contact IC communication transmitting and receiving circuit 23, an intra-body communication transmitting and receiving circuit 24, and a communication electrode 25. The loop antenna 22 receives a signal transmitted from the reader-writer 11 by receiving the magnetic field generated by the loop antenna 21. Moreover, the loop antenna 22 transmits a signal for non-contact IC card communications to the reader-writer 11.

The non-contact IC communication transmitting and receiving circuit 23 obtains the signal received by the loop antenna 22 and supplies the signal to the intra-body communication transmitting and receiving circuit 24. Moreover, when the signal is supplied from the intra-body communication transmitting and receiving circuit 24, the non-contact IC communication transmitting and receiving circuit 23 makes the loop antenna 22 transmit the signal. The intra-body communication transmitting and receiving circuit 24 converts the signal for non-contact IC card communications supplied from the non-contact IC communication transmitting and receiving circuit 23 into a signal for intra-body communications, and transmits the signal obtained by the conversion via the communication electrode 25 to the communication terminal apparatus 13 by using the human body as the communication medium. Moreover, the intra-body communication transmitting and receiving circuit 24 receives the signal for intra-body communications transmitted from the communication terminal apparatus 13 via the human body 15 by detecting a potential difference generated between the ground and the communication electrode 25, converts the received signal into a signal for non-contact IC card communications, and supplies the resulting signal to the non-contact IC communication transmitting and receiving circuit 23.

The communication electrode 25 is electrostatically coupled to the human body 15. Then, the communication electrode 25 performs transmitting and receiving of the signal for intra-body communications by utilizing a potential difference from the ground serving as a reference point.

The communication terminal apparatus 13 performs intra-body communications with the communication terminal apparatus 12 using the human body 15 as a communication medium, and performs wireless communications in a non-contact manner with the non-contact IC card 14, i.e., non-contact IC card communications. The communication terminal apparatus 13 includes a communication electrode 26, an intra-body communication transmitting and receiving circuit 27, a non-contact IC communication transmitting and receiving circuit 28, and a loop antenna 29.

Moreover, the communication electrode 26 is electrostatically coupled to the human body 15, and performs transceiving and receiving of the signal for intra-body communications by utilizing a potential difference from the ground (not shown) as a reference point provided to the intra-body communication transmitting and receiving circuit 27.

The intra-body communication transmitting and receiving circuit 27 converts the signal for intra-body communications received at the communication electrode 26 into a signal for non-contact IC card communications, and supplies the resulting signal to the non-contact IC communication transmitting and receiving circuit 28. Moreover, the intra-body communication transmitting and receiving circuit 27 converts the signal for non-contact IC card communications supplied from the non-contact IC communication transmitting and receiving circuit 28 into a signal for intra-body communications, and transmits the signal obtained by the conversion from the communication electrode 26 to the communication terminal apparatus 12. Moreover, the intra-body communication transmitting and receiving circuit 27 transmits a signal to the communication terminal apparatus 12 via the human body 15 by generating a potential difference between the ground and the communication electrode 26 in accordance with the signal (data) for intra-body communications to be transmitted.

Further, the non-contact IC communication transmitting and receiving circuit 28 generates a magnetic field by flowing a current to the loop antenna 29 in accordance with the signal supplied from the intra-body communication transmitting and receiving circuit 27, and transmits the signal to the non-contact IC card 14. Moreover, the non-contact IC communication transmitting and receiving circuit 28 obtains a signal from the non-contact IC card 14 received at the loop antenna 29, and supplies the signal to the intra-body communication transmitting and receiving circuit 27.

The loop antenna 29 transmits the signal for non-contact IC card communications to the non-contact IC card 14 by generating a magnetic field in accordance with control of the non-contact IC communication transmitting and receiving circuit 28, and receives the signal transmitted from the non-contact IC card 14 by receiving a variation in the load of the non-contact IC card 14. The non-contact IC card 14 includes a loop antenna 30 for performing wireless communications in a non-contact manner, and performs non-contact IC card communications with the communication terminal apparatus 13 by varying the load of the loop antenna 30 or receiving the magnetic field at the loop antenna 30. Moreover, the non-contact IC card 14 transmits the signal for non-contact IC card communications to the loop antenna 30 by generating a magnetic field corresponding to data at the loop antenna 30 by varying the load to the loop antenna 30 in accordance with the data to be transmitted.

However, since the communication terminal apparatuses 12 and 13 include the intra-body communication transmitting and receiving circuits 24 and 27, respectively, the communication terminal apparatuses 12 and 13 have such problems as complicated configurations and increased power consumption.

### SUMMARY

The present disclosure provides an intra-body communication apparatus and communication equipment capable of reducing power consumption with a simple configuration.

According to one example of the present disclosure, an intra-body communication apparatus includes an antenna coil configured to wirelessly communicate a magnetic induction signal with communication equipment by using magnetic induction at a carrier frequency, an electrode for a human body, the electrode connected to the antenna coil, and a resonance circuit including the antenna coil. The resonance circuit resonates at the carrier frequency. The intra-body communication apparatus is configured to transmit the magnetic induction signal from the communication equipment received by the antenna coil to the human body via the resonance circuit at the carrier frequency, without converting or changing a frequency of the magnetic induction signal.

According to another example of the present disclosure, an intra-body communication apparatus includes an antenna coil, an electrode for a human body, and a resonance circuit. The antenna coil is configured to transmit and receive a magnetic induction signal from communication equipment including a magnetic induction wireless communication circuit that performs wireless communications by using magnetic induction. The electrode is connected to the antenna coil. The resonance circuit includes the antenna coil and the electrode for the human body, and the resonance circuit resonates at a carrier frequency of the magnetic induction signal. The magnetic induction signal is transmitted from the communication equipment to communication equipment of another party via the human body at a frequency that is a carrier frequency of the magnetic induction signal propagating in the human body being equal to a carrier frequency of the magnetic induction signal propagating in the communication equipment.

In any of the above-mentioned intra-body communication apparatus, the resonance circuit may include only the antenna coil and a passive device.

In any of the above-mentioned intra-body communication apparatus, the resonance circuit may consist of the antenna coil, a passive device and wires connecting the antenna coil and the passive device.

In addition, in any of the above-mentioned intra-body communication apparatus, the passive device may be a capacitor.

Further, in any of the above-mentioned intra-body communication apparatus, the intra-body communication apparatus may further include the communication equipment, and be disposed in a housing different from a housing of the communication equipment.

Still further, in any of the above-mentioned intra-body communication apparatus, the intra-body communication apparatus may be arranged detachably to the communication equipment.

Still further, any of the above-mentioned intra-body communication apparatus may further include a switching device provided between the antenna coil and the electrode for the human body. The switching device is configured to connect or disconnect the antenna coil to or from the electrode.

In addition, in any of the above-mentioned intra-body communication apparatus, the intra-body communication apparatus may include a plurality of electrodes for the human body, and at least one electrode of the plurality of electrodes for the human body may transmit a magnetic induction signal by being coupled to a space around the human body without being brought in contact with the human body.

Further, in any of the above-mentioned intra-body communication apparatus, the electrode for the human body may have a surface coated with a resin layer, and the magnetic induction signal may be transmitted via a capacitance formed between the surface of the human body and the electrode.

According to yet another example of the present disclosure, a communication apparatus includes an antenna coil configured to transmit and receive a magnetic induction signal, a magnetic induction wireless communication circuit configured to wirelessly communicate the magnetic induction signal by using magnetic induction, an electrode for a human body, and a switching device configured to connect or disconnect a communication between the magnetic induction wireless communication circuit and the electrode for the human body. When the switching device connects the magnetic induction wireless communication circuit with the electrode for the human body, the magnetic induction signal is transmitted from the magnetic induction wireless communication circuit to the human body via the electrode for the human body. A carrier frequency of the magnetic induction signal transmitted to the human body is equal to a carrier frequency of the magnetic induction signal propagating in the magnetic induction wireless communication circuit.

According to another example of the present disclosure, there is provided communication equipment including a magnetic induction wireless communication circuit that performs wireless communications using magnetic induction, and the communication equipment includes an antenna coil, an electrode for a human body, and switching device. The antenna coil is configured to transmit and receive a magnetic induction signal, and the switching device is inserted between the magnetic induction wireless communication circuit, and the antenna coil and the electrode for the human body. The switching device performs selective switchover between a connection of the magnetic induction wireless communication circuit with the antenna coil and a connection of the magnetic induction wireless communication circuit with the electrode for the human body. The switching device transmits the magnetic induction signal from the communication equipment to communication equipment of another party via the human body when the switching device is connecting the magnetic induction wireless communication circuit with the electrode for the human body. A carrier frequency of the magnetic induction signal propagating in the human body is equal to a carrier frequency of the magnetic induction signal propagating in the magnetic induction wireless communication circuit.

According to one example of the present disclosure, there is provided communication equipment including a magnetic induction wireless communication circuit that performs wireless communications using magnetic induction, and the communication equipment includes an antenna coil, an electrode for a human body, and switching device. The antenna coil is configured to transmit and receive a magnetic induction signal, and the electrode for the human body is connected to the antenna coil. The switching device is inserted between the magnetic induction wireless communication circuit, and the antenna coil and the electrode for the human body. The switching device turns on or off a connection of the magnetic induction wireless communication circuit with the antenna coil and connection with the electrode for the human body. The switching device transmits the magnetic induction signal from the communication equipment to communication equipment of another party via the human body when the connection is turned on. A carrier frequency of the magnetic induction signal propagating in the human body is equal to a carrier frequency of the magnetic induction signal propagating in the magnetic induction wireless communication circuit.

Further, a communication method using a human body according to one example of the present disclosure includes the following steps. A magnetic induction signal is received from communication equipment at an antenna coil. The magnetic induction signal is carried by a wave having a carrier frequency. The received magnetic induction signal is transmitted via a resonance circuit including the antenna coil to an electrode for a human body and then to the human body. The resonance circuit resonates at the carrier frequency. The received magnetic induction signal is transmitted at the carrier frequency, and a frequency of the magnetic induction signal is not converted or changed from the antenna coil to the electrode for a human body.

According to the intra-body communication apparatus and communication equipment of the present disclosure, stable communications can be performed with a simple configuration by using a human body as a transmission path without adding a further transmitting and receiving circuit in a short-distance wireless communication apparatus using magnetic induction. Moreover, the power consumption can be reduced.

### BRIEF DESCRIPTION OF THE DRAWINGS

These and other objects and features of the disclosure will become clear from the following description taken in conjunction with the preferred embodiments thereof with reference to the accompanying drawings throughout which like parts are designated by like reference numerals, and in which:

FIG. 1 is a block diagram showing an example of a configuration of an intra-body communication system including intra-body communication apparatuses 104 and 105 connected via a human body 103;

FIG. 2A is a perspective view showing an example of a configuration of the intra-body communication apparatus 104 of FIG. 1;

FIG. 2B is a circuit diagram showing an example of a circuit of the intra-body communication apparatus 104 of FIG. 2A;

FIG. 3A is a block diagram showing another example of a configuration of an intra-body communication apparatus 104A;

FIG. 3B is a circuit diagram showing an example of a circuit of the intra-body communication apparatus 104A of FIG. 3A;

FIG. 3C is a circuit diagram showing another example of a circuit of the intra-body communication apparatus 104A of FIG. 3A;

FIG. 4A is a block diagram showing an example of a configuration of an intra-body communication apparatus 104B in communication equipment 101A;

FIG. 4B is a circuit diagram showing an example of a circuit of the intra-body communication apparatus 104B in the communication equipment 101A of FIG. 4A;

FIG. 5A is a block diagram showing an additional example of a configuration of an intra-body communication apparatus 104C in communication equipment 101B;

FIG. 5B is a circuit diagram showing an example of a circuit of an intra-body communication apparatus 104C in the communication equipment 101B of FIG. 5A;

FIG. 6 is a perspective view showing one example of an arrangement of electrodes 107a and 107b for the human body in an intra-body communication apparatus 104;

FIG. 7 is a perspective view showing another example of an arrangement of the electrodes 107a and 107b for the human body;

FIG. 8 is a block diagram showing an example of a configuration of an intra-body communication system including intra-body communication apparatuses 104 and 105 connected via the human bodies 103A and 103B of two persons;

FIG. 9 is a graph showing the frequency characteristics of the reception intensity in communication equipment 102 on a receiving side according to an implemental example of the intra-body communication system of FIG. 1; and

FIG. 10 is a block diagram showing an example of a configuration of the prior art intra-body communication system.

### DETAILED DESCRIPTION

Various embodiments of the present subject matter will be described below with reference to the drawings. In the following embodiments, like components are denoted by like reference numerals.

With regard to the present embodiment, embodiments of intra-body communication apparatuses and communication equipment having a short-distance wireless communication function using magnetic induction are described in detail below. In the present disclosure, the embodiments are generally directed to intra-body communication apparatuses applied with communication equipment having the short-distance wireless communication function using magnetic induction. The structure of the communication equipment having the short-distance wireless communication function using magnetic induction is well-known and not limited to any specific structure, and therefore, no description is provided for the structure of the communication equipment having the short-distance wireless communication function.

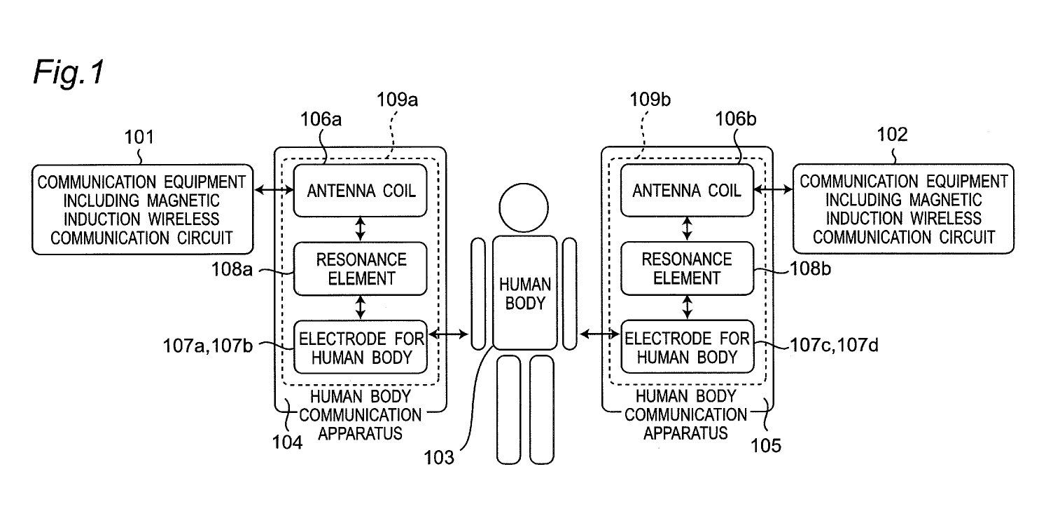

FIG. 1 is a block diagram showing an example of a configuration of an intra-body communication system including intra-body communication apparatuses 104 and 105 connected via a human body 103.

Referring to FIGS. 1, 101 and 102 denote communication equipment including a magnetic induction wireless communication circuit having a short-distance wireless communication function using magnetic induction of the NFC standard or the like, 103 denotes a human body that serves as a transmission medium, and 104 and 105 denote intra-body communication apparatuses of the present embodiment. The intra-body communication apparatus 104 of the present embodiment includes a resonance circuit 109a, and the resonance circuit 109a is configured to include an antenna coil 106a for short-distance wireless communications to transmit and receive magnetic induction signals using magnetic induction, and electrodes 107a and 107b for the human body. The intra-body communication apparatus 104 further includes a resonance device 108a that includes, for example, a capacitor as a passive device, and resonates at a carrier frequency used for the short-distance wireless communications using magnetic induction when the electrodes for the human body are in a state used for intra-body communications. Moreover, the intra-body communication apparatus 105 of the present embodiment includes a resonance circuit 109b, and the resonance circuit 109a is configured to include an antenna coil 106b for the short-distance wireless communications using magnetic induction, and electrodes 107c and 107d for the human body. The intra-body communication apparatus 105 further includes a resonance device 108b that includes, for example, a capacitor, and resonates at a carrier frequency used for the short-distance wireless communications using magnetic induction when the electrodes for the human body are in a state used for intra-body communications. The resonance devices 108a and 108b may each be configured by including not only the capacitor but also an inductor.

Next, a method of transmitting and receiving signals by the intra-body communication apparatuses 104 and 105 of the embodiment of the present disclosure is described with reference to FIG. 1.

Referring to FIG. 1, a magnetic induction signal transmitted from the communication equipment 101 is received by the antenna coil 106a provided at the intra-body communication apparatus 104. The communication equipment 101 includes a magnetic induction wireless communication circuit having a short-distance wireless communication function using magnetic induction. Thereafter, the magnetic induction signal is transmitted to the electrodes 107a and 107b for the human body in a state of highest efficiency at the carrier frequency of the magnetic induction signal via the resonance circuit 109a having a resonance frequency substantially identical to that of the carrier frequency of the magnetic induction signal. The electrodes 107a and 107b for the human body are electrically connected and linked to the electrodes 107c and 107d for the human body via the human body 103, and the signal transmitted from the electrodes 107a and 107b for the human body to the human body 103 is further transmitted to the electrodes 107c and 107d for the human body of another intra-body communication apparatus 105 via the human body 103. The transmitted signal is transmitted from the antenna coil 106b provided at the intra-body communication apparatus 105 in a state of the highest efficiency at the carrier frequency of the magnetic induction signal via the resonance circuit 109b having a resonance frequency substantially identical to the carrier frequency of the magnetic induction signal. The transmitted signal is received by the communication equipment 102 including a magnetic induction wireless communication circuit having the short-distance wireless communication function using magnetic induction.

Moreover, since the signal flow of the intra-body communication system of the present embodiment has reversibility, it is possible to transmit a signal from the communication equipment 102 to the communication equipment 101 via the intra-body communication apparatus 105, the human body 103 and the intra-body communication apparatus 104.

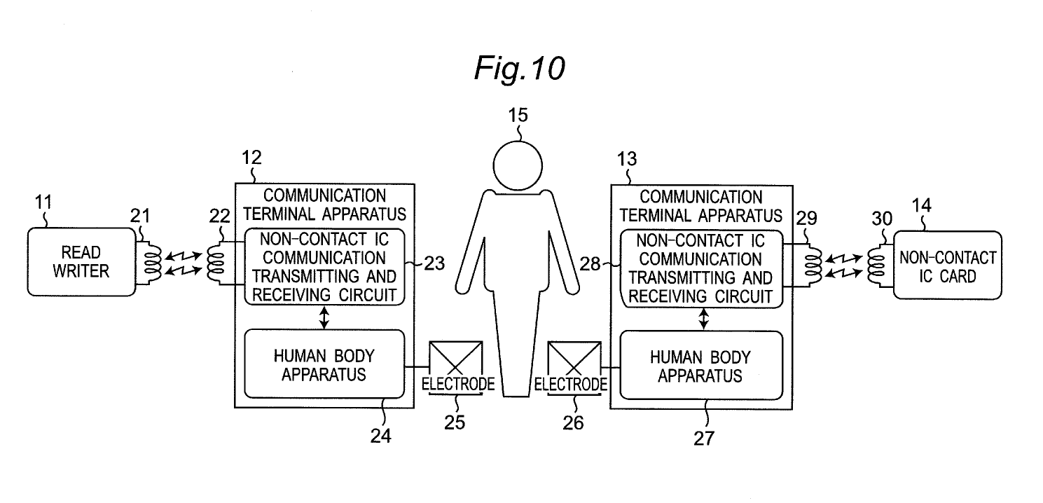

In the intra-body communication system configured as above, to transmit/receive signals between the communication equipment 101 and the communication equipment 102, the transmitting and receiving circuits (23 and 28 of FIG. 10) separately provided for the magnetic induction communications are unnecessary. Therefore, it is easy to reduce size and save energy since it can be configured to include only the intra-body communication apparatuses 104 and 105 of a simple configuration.

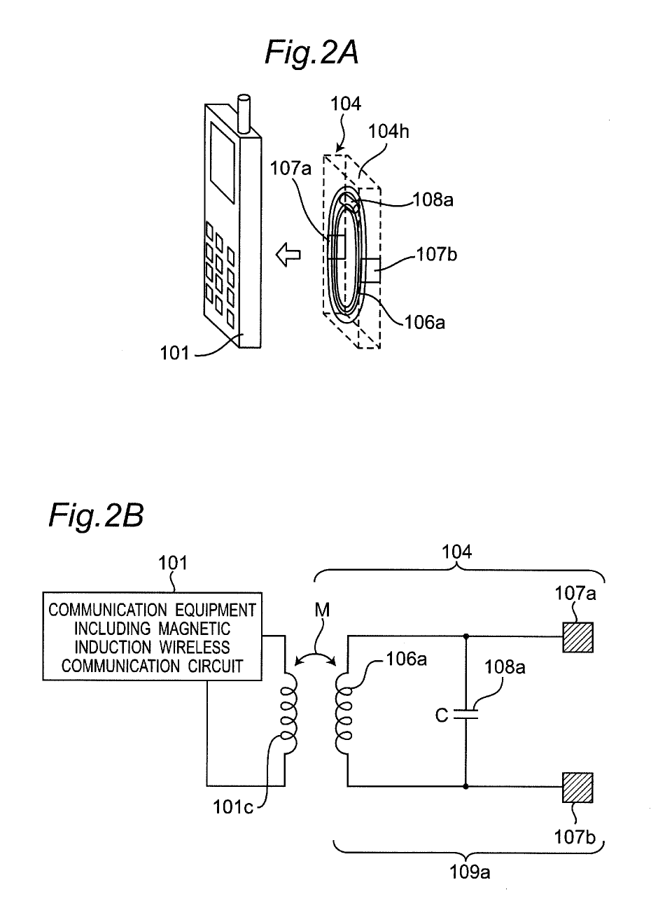

FIG. 2A is a perspective view showing an example of a configuration of the intra-body communication apparatus 104 of FIG. 1. It is noted that the intra-body communication apparatus 105 of FIG. 1 is also configured in a manner similar to that of the intra-body communication apparatus 104 of FIG. 2A. Referring to FIG. 2A, the antenna coil 106a for the short-distance wireless communications using magnetic induction is provided in a housing 104h of the intra-body communication apparatus 104, and the antenna coil 106a is connected to the resonance device 108a. Further, the resonance device 108a is connected to the electrodes 107a and 107b for the human body provided on the housing 104h of the intra-body communication apparatus 104. These circuit elements are connected by wires. The intra-body communication apparatus 104 can be configured detachable from the communication equipment 101.

FIG. 2B is a circuit diagram showing an example of a circuit of the intra-body communication apparatus 104 of FIG. 2A. It is noted that the intra-body communication apparatus 105 of FIG. 1 is configured in a manner similar to that of the intra-body communication apparatus 104 of FIG. 2B. Referring to FIG. 2B, the antenna coil 101c of the communication equipment 101 including the magnetic induction wireless communication circuit is connected to the antenna coil 106a of the intra-body communication apparatus 104 by inductive coupling M. The antenna coil 106a is connected in parallel with a resonance device 108a that is, for example, a capacitor C between the electrodes 107a and 107b for the human body. The capacitance of the capacitor C of the resonance device 108a is determined so that the resonance device 108a configures a resonance circuit 109a having a resonance frequency substantially identical to the carrier frequency of the magnetic induction signal transmitted from the antenna coil 101c of the communication equipment 101 when the electrodes 107a and 107b for the human body are in a state of performing intra-body communications with respect to the human body. One end of the antenna coil 106a is connected to the electrode 107a for the human body, and the other end is connected to the electrode 107b for the human body. In this case, the resonance circuit 109a is configured only of, for example, LC passive devices and having no active device.

In the intra-body communication apparatus 104 of FIG. 2B configured as above, the magnetic induction signal transmitted from the antenna coil 101c of the communication equipment 101 is received by the antenna coil 106, thereafter, the transmitted signal is subjected to band-pass filtering by the resonance circuit 109a, and is transmitted to the electrodes 107a and 107b for the human body.

The intra-body communication apparatus 104 configured as above is configured to include a housing separate from that of the communication equipment 101 including the magnetic induction wireless communication circuit. Therefore, it is not necessary to dispose the intra-body communication apparatus 104 and the communication equipment 101 in the same housing, and it is possible to easily achieve an intra-body communication function without newly adding a function to the communication equipment 101. Moreover, since the intra-body communication apparatus 104 may have a structure detachable from the communication equipment 101, the short-distance wireless communication function using magnetic induction provided by the communication equipment 101 is not impaired.

Moreover, in the intra-body communication system that utilizes the short-distance wireless communications using magnetic induction, the communication distance of bi-directional communications between the communication equipment 101 and 102 on which the short-distance wireless communication technology using magnetic induction is mounted can be extended without adding other transmitting and receiving circuits (23 and 28 of FIG. 10) nor adding anything to the configuration of the communication equipment 101 and 102.

Further, by configuring the resonance circuit 109a of only a passive device of, for example, a capacitor or the like, it is not required to supply the intra-body communication apparatus 104 with power, giving no influence on the power consumption of the communication equipment 101.

Furthermore, the communication equipment 101 and the intra-body communication apparatus 104, which need not to be an integrated structure as shown in FIG. 2A, can therefore be easily separated, and the short-distance wireless communication function (function of the magnetic induction wireless communication circuit) using magnetic induction provided by the communication equipment 101 is not impaired.

As described above, according to the present embodiment, stable communications can be performed by using the human body 103 as a transmission path for the extension of the communication distance of the short-distance wireless communications using magnetic induction by the detachable structure with no power supply, and the restrictions on the communication distance of the prior art short-distance wireless communications using magnetic induction can be eliminated. Therefore, it is possible to actualize intra-body communication apparatuses 104 and 105 that have no restrictions on the mutual positions and directions between the communication equipment 101 and 102, and do not impair the short-distance wireless communication function using magnetic induction of the communication equipment 101 and 102 by further easily separating one from another.

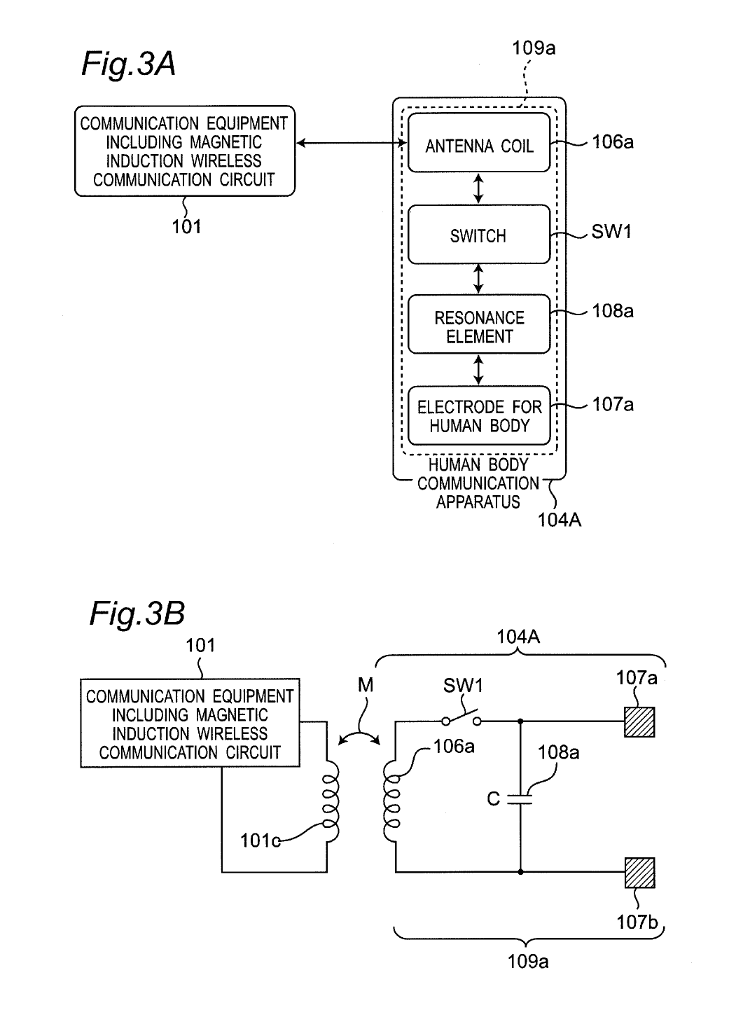

FIG. 3A is a block diagram showing another example of a configuration of an intra-body communication apparatus 104A. It is noted that the intra-body communication apparatus 105 of FIG. 1 is also configured in a manner similar to that of the intra-body communication apparatus 104 of FIG. 3A. The intra-body communication apparatus 104A of FIG. 3A is characterized in that a switch SW1 is provided in the intra-body communication apparatus 104A compared with the intra-body communication apparatus 104 of FIG. 1. Referring to FIG. 3A, the intra-body communication apparatus 104A includes a resonance circuit 109a, and the resonance circuit 109a is configured to include an antenna coil 106a for short-distance wireless communications using magnetic induction, the switch SW1 that is provided between the antenna coil 106a and the resonance device 108a and turns on and off an electric signal, the resonance device 108a of, for example, a capacitor, and an electrode 107a for the human body.

In the intra-body communication apparatus 104A configured as above, the switch SW1 is turned on to operate as the intra-body communication apparatuses 104 of FIG. 1 when intra-body communications are used or the switch SW1 is turned off to separate the resonance device 108a from the antenna coil 106a for short-distance wireless communications when intra-body communications are not used, so that the resonance frequency of the antenna coil 106a for short-distance wireless communications changes from the carrier frequency used for short-distance wireless communications using magnetic induction. Therefore, by turning off the switch SW1, the short-distance wireless communications that do not use intra-body communications but use electromagnetic induction can be performed even in a state in which the intra-body communication apparatus 104A is connected to the communication equipment 101. That is, by tuning on and off the switch SW1, the intra-body communication function can be achieved not impairing the short-distance wireless communications using magnetic induction provided by the communication equipment 101.

FIG. 3B is a circuit diagram showing an example of a circuit of the intra-body communication apparatus 104A of FIG. 3A. The intra-body communication apparatus 104A of FIG. 3B is characterized in that the switch SW1 is inserted between the antenna coil 106 and the capacitor C as compared with the intra-body communication apparatus 104 of FIG. 2B. The other configuration is similar to that of FIG. 2B.

FIG. 3C is a circuit diagram showing another example of a circuit of the intra-body communication apparatus 104A of FIG. 3A. The intra-body communication apparatus 104A of FIG. 3C is characterized in that the switch SW1 is inserted between the electrode 107a for the human body and the capacitor C as compared with the intra-body communication apparatus 104A of FIG. 3B. The other configuration is similar to that of FIG. 3B. Even with this configuration, the electrodes 107a and 107b for intra-body communications are separated from each other by turning off the switch SW1, and the resonance frequency of the antenna coil 106a for short-distance wireless communications is changed from the carrier frequency used for short-distance wireless communications using magnetic induction. That is, the actions and advantageous effects similar to those of the intra-body communication apparatus 104A of FIG. 3B can be produced.

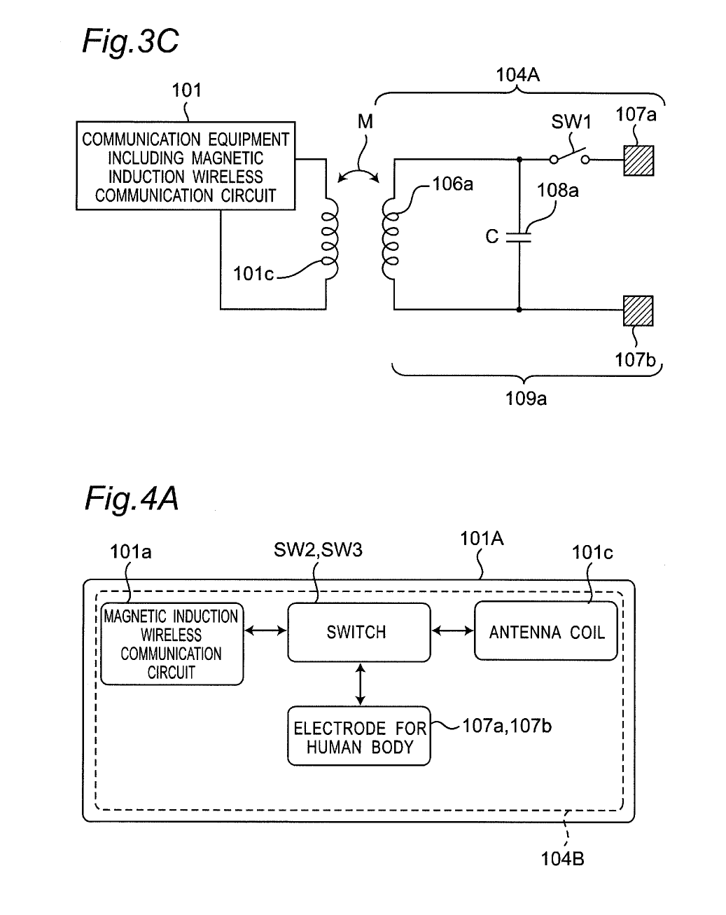

FIG. 4A is a block diagram showing an example of a configuration of an intra-body communication apparatus 104B in communication equipment 101A. The intra-body communication apparatus 104B of FIG. 4A is characterized in that switches SW2 and SW3 are provided in the communication equipment 101A having a short-distance wireless communication function using magnetic induction. The intra-body communication apparatus 104B is configured to include a magnetic induction wireless communication circuit 101a, an antenna coil 101c, electrodes 107a and 107b for the human body, and the switches SW2 and SW3 for switch over of signal paths between the magnetic induction wireless communication circuit 101a and the antenna coil 101c and the electrodes 107a and 107b.

In the intra-body communication apparatus 104B of FIG. 4A, when intra-body communications are used, the switches SW2 and SW3 are switched over to a path for connection from the magnetic induction wireless communication circuit 101a to the electrodes 107a and 107b for the human body. On the other hand, when intra-body communications are not used, the switches SW2 and SW3 are switched over to a path for connection from the magnetic induction wireless communication circuit 101a to the antenna coil 101c.

FIG. 4B is a circuit diagram showing an example of a circuit of the intra-body communication apparatus 104B in the communication equipment 101A of FIG. 4A. Referring to FIG. 4B, the switches SW2 and SW3 are interlocked and switched over to a contact “a” side at the same time when intra-body communications are used to perform switchover to the path for connection from the magnetic induction wireless communication circuit 101a to the electrodes 107a and 107b for the human body. The switches SW2 and SW3 are interlocked and switched over to a contact “b” side at the same time when intra-body communications are not used to perform switchover to the path for connection from the magnetic induction wireless communication circuit 101a to the antenna coil 101c.

In the present embodiment configured as above, the intra-body communication function can be provided not impairing the function of short-distance wireless communications using magnetic induction provided by the communication equipment 101A by selectively switching the switches SW2 and SW3.

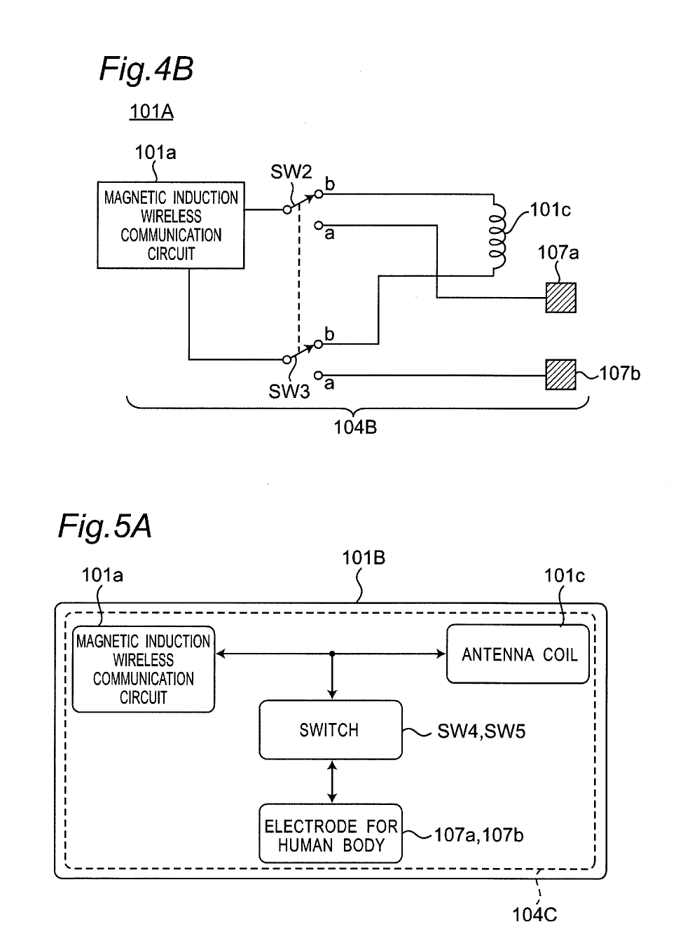

FIG. 5A is a block diagram showing an additional example of a configuration of an intra-body communication apparatus 104C in the communication equipment 101B. The intra-body communication apparatus 104C of FIG. 5A is characterized in that switches SW4 and SW5 are provided in place of the switches SW2 and SW3 as compared with the intra-body communication apparatus 104B of FIG. 4A. The intra-body communication apparatus 104C of FIG. 5A is configured to include a magnetic induction wireless communication circuit 101a, an antenna coil 101c, electrodes 107a and 107b for the human body, and the switches SW4 and SW5 that are provided between the magnetic induction wireless communication circuit 101a and the antenna coil 101c and the electrodes 107a and 107b for the human body and to turn on and off signal transmission.

In the intra-body communication apparatus 104C configured as above, the electrodes 107a and 107b for the human body are separated from the magnetic induction wireless communication circuit 101a and the antenna coil 101c by turning on the switches SW4 and SW5 when intra-body communications are used or turning off the switches SW4 and SW5 when intra-body communications are not used.

FIG. 5B is a circuit diagram showing an example of a circuit of the intra-body communication apparatus 104C in the communication equipment 101B of FIG. 5A. Referring to FIG. 5B, the magnetic induction wireless communication circuit 101a is always connected to the antenna coil 101c. The magnetic induction wireless communication circuit 101a is further connected to electrodes 107a and 107b for the human body via the switches SW4 and SW5.

As described above, it is possible to perform selective switchover as to whether or not intra-body communications are performed by turning on and off the switches SW4 and SW5, and the intra-body communication function can be provided not impairing the function of short-distance wireless communications using magnetic induction provided by the communication equipment 101B.

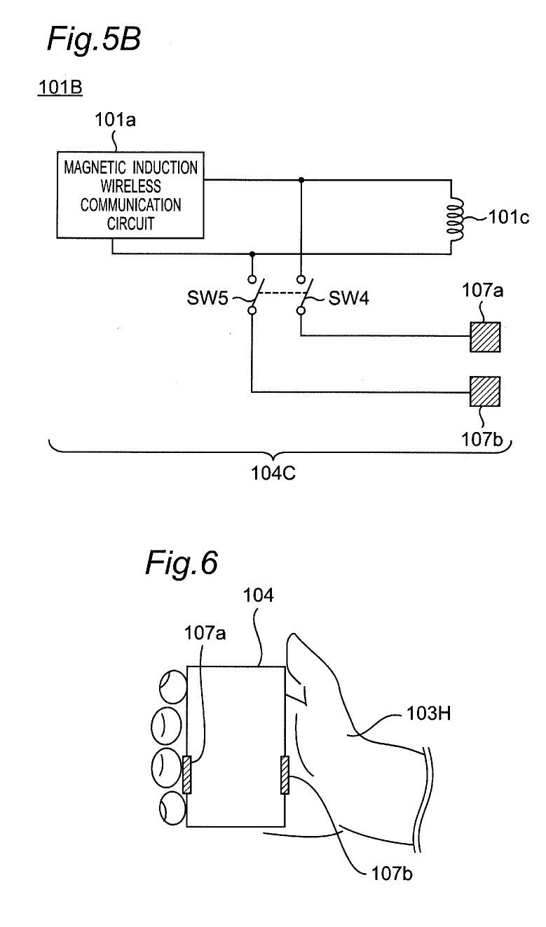

FIG. 6 is a perspective view showing one example of an arrangement of the electrodes 107a and 107b for the human body in an intra-body communication apparatus 104. The other configuration in the intra-body communication apparatus 104 is just like that of the aforementioned embodiment, and the present embodiment can be applied also to the intra-body communication apparatus 105. Referring to FIG. 6, the electrodes 107a and 107b for the human body are formed on the right and left side surfaces of the intra-body communication apparatus 104, and the electrodes 107a and 107b for the human body are characterized in that they are both brought in contact with the hand 103H of the human body that serves as a transmission medium to transmit a signal via the human body.

It is acceptable to coat the surfaces of the electrodes 107a and 107b for intra-body communications with a thin resin layer and transmit a signal via capacitance coupling between the human body skin surface and the electrodes 107a and 107b. Moreover, although the case where the two electrodes 107a and 107b for the human body are provided is described in FIG. 6, the configuration is not limited to this but allowed to have three or more electrodes for the human body. Further, although the case where the intra-body communication apparatus 104 is held by the hand 103H of the human body is shown in FIG. 6, the portion of the human body to be brought in contact with the electrodes 107a and 107b for the human body is not limited to this but allowed to be another portion of the human body. Moreover, the positions of the electrodes 107a and 107b for the human body in FIG. 6 show one example of an arrangement of the intra-body communication apparatus 104, and the electrodes may be formed in other positions. Moreover, although the intra-body communication apparatus 104 has been described here, the same configuration is also possible for the intra-body communication apparatus 104B and the intra-body communication apparatus 104C.

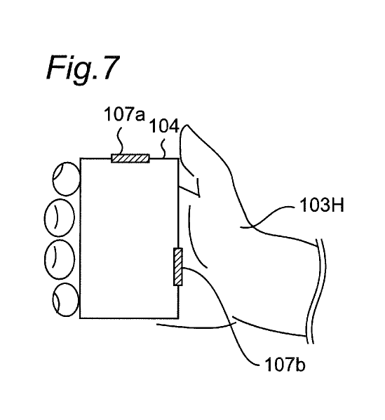

FIG. 7 is a perspective view showing another example of an arrangement of the electrode 107a and 107b for the human body in an intra-body communication apparatus 104. The other configuration in the intra-body communication apparatus 104 is the same as that of the aforementioned embodiment, and the present embodiment can be applied also to the intra-body communication apparatus 105. Referring to FIG. 7, the electrodes 107a and 107b for the human body are formed on the upper surface and the right side surface of the intra-body communication apparatus 104, and the electrode 107b for the human body is brought in contact with the hand 103H of the human body that serves as a transmission medium. However, the apparatus is characterized in that the electrode 107a for the human body is not brought in contact with the hand 103H of the human body that serves as the transmission medium but transmitting a signal via the human body with the peripheral free space serving as a reference potential. In this case, the electrode for the human body that is not brought in contact may be at least one of a plurality of electrodes.

It is acceptable to coat the surfaces of the electrodes 107a and 107b for intra-body communications with a thin resin layer and transmit a signal via the electrostatic capacitance of the resin layer between the human body skin surface and the electrodes 107a and 107b. Moreover, although FIG. 7 describes the case where the two electrodes 107a and 107b for the human body are provided, the aforementioned configuration is not limited to this but allowed to have three or more electrodes for the human body. Further, although the example in which the intra-body communication apparatus 104 is held by the hand 103H of the human body is shown in FIG. 7, the portion of the human body to be brought in contact with the electrodes 107a and 107b for the human body is not limited to this but allowed to be another portion of the human body. Furthermore, the positions of the electrodes 107a and 107b for the human body in FIG. 7 show one arrangement example of the intra-body communication apparatus 104, and the electrodes may be formed in other positions. Moreover, although the intra-body communication apparatus 104 has been described here, the same configuration is possible for the intra-body communication apparatus 104B and the intra-body communication apparatus 104C.

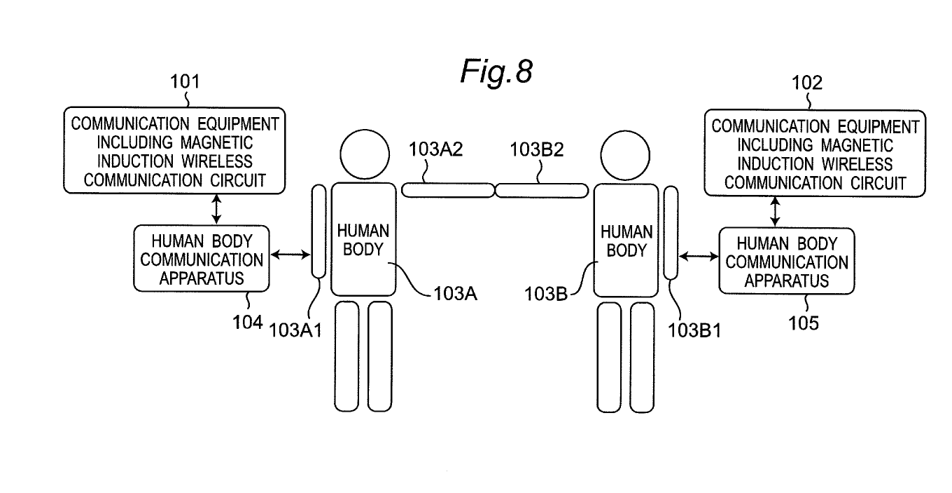

FIG. 8 is a block diagram showing an example of a configuration of an intra-body communication system including intra-body communication apparatuses 104 and 105 connected via the human bodies 103A and 103B of two persons. In FIG. 8, the magnetic induction wireless communication circuit 101 includes a short-distance wireless communication function using magnetic induction. A signal is transmitted from the magnetic induction wireless communication circuit 101 to the communication equipment 102, via the intra-body communication apparatus 104, the hand 103A1 holding the intra-body communication apparatus 104, the main body 103A of the human body, the hand 103A2 of the human body, the hand 103B2 of the other human body 103B, the main body of the human body, the hand 103B1 of the human body 103B, and the intra-body communication apparatus 105 held by the human body 103B. The human body 103A and the other human body 104B serve as a transmission medium.

Although the intra-body communication apparatus 104 is used in the intra-body communication system of FIG. 8, the configuration is not limited to this but allowed to use intra-body communication apparatuses 104A, 104B and 104C. Moreover, although the intra-body communication apparatus 105 is used, the configuration is not limited to this but allowed to use intra-body communication apparatuses 105A, 105B and 105C.

Although the case of the human bodies 103A and 103B of two persons has been described in the above embodiment, the configuration is not limited to this but allowed to transmit a signal via the human bodies of three or more persons.

Although the case of the example of signal transmission between the communication equipment 101 and 102 each including the magnetic induction wireless communication circuit utilizing the short-distance wireless communication technology using magnetic induction in each of the aforementioned embodiments, the present disclosure is not limited to this. Either one of the communication equipment 101 and 102 may be a terminal for communications having only the function of intra-body communications.

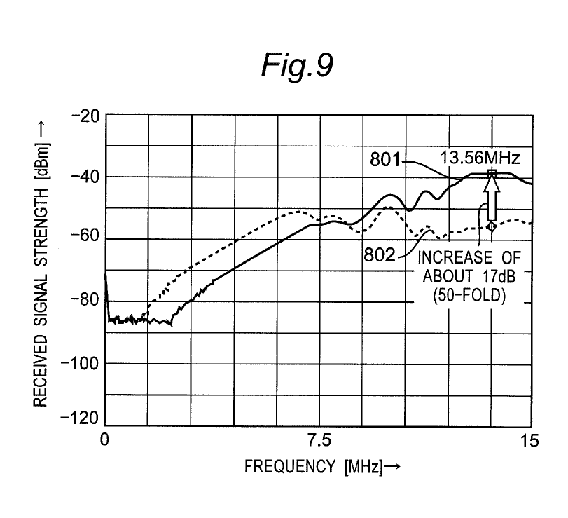

FIG. 9 is a graph showing the carrier frequency characteristics of the reception intensity in the communication equipment 102 on the receiving side according to an implemental example of the intra-body communication system of FIG. 1. In FIG. 9, the solid line 801 shows the frequency characteristic when the intra-body communication apparatus of the present disclosure is used, and the dotted line 802 shows the frequency characteristic in the absence of the intra-body communication apparatus. As shown in FIG. 9, a gain increased about 17 dB at the carrier frequency of 13.56 MHz by using the intra-body communication apparatus. Such an increase of the gain makes it possible to stably transmit signals and to extend the communication distance. It is noted that the numerical values shown in FIG. 9 indicate one example of the characteristics, and limit neither the embodiments of the present disclosure nor the frequency at which the gain is increased.

The intra-body communication apparatus of the present disclosure has the features that no restrictions are imposed on the mutual positional relation of the communication equipment when short-distance wireless communications are performed using magnetic induction, and the communication equipment can be used without impairing the functions of the communication equipment by performing communications using the human body as a transmission medium only by attaching the communication equipment having short-distance wireless communications using magnetic induction to the simple intra-body communication apparatus, and is useful as an intra-body communication apparatus that improves the convenience of short-distance wireless communications using magnetic induction.

Although the disclosure has been fully described in connection with the preferred embodiments thereof with reference to the accompanying drawings, it is to be noted that various changes and modifications are apparent to those skilled in the art. Such changes and modifications are to be understood as included within the scope of the disclosure as defined by the appended claims unless they depart therefrom.

What is claimed is:

1. An intra-body communication apparatus comprising:
an antenna coil configured to wirelessly communicate a magnetic induction signal with communication equipment by using magnetic induction at a carrier frequency;
an electrode for a human body, the electrode connected to the antenna coil; and
a resonance circuit including the antenna coil, the resonance circuit resonating at the carrier frequency,
wherein the intra-body communication apparatus is configured to transmit the magnetic induction signal from the communication equipment received by the antenna coil to the human body via the resonance circuit at the carrier frequency, without converting or changing a frequency of the magnetic induction signal.

2. The intra-body communication apparatus as claimed in claim 1,
wherein the resonance circuit consists of the antenna coil, a passive device and wires connecting the antenna coil and the passive device.

3. The intra-body communication apparatus as claimed in claim 2,
wherein the passive device is a capacitor.

4. The intra-body communication apparatus as claimed in claim 1,
wherein the intra-body communication apparatus further comprises the communication equipment, and
wherein the intra-body communication apparatus is disposed in a housing different from a housing of the communication equipment.

5. The intra-body communication apparatus as claimed in claim 4,
wherein the intra-body communication apparatus is arranged detachably to the communication equipment.

6. The intra-body communication apparatus as claimed in claim 1, further comprising:
a switch disposed between the antenna coil and the electrode for the human body and configured to connect or disconnect the antenna coil to or from the electrode.

7. The intra-body communication apparatus as claimed in claim 1,
wherein the apparatus comprises a plurality of electrodes for the human body, and
wherein at least one electrode of the plurality of electrodes for the human body transmits the magnetic induction signal by being coupled to a space around the human body without being brought in contact with the human body.

8. The intra-body communication apparatus as claimed in claim 1,
wherein the electrode for the human body has a surface coated with a resin layer.

9. A communication apparatus comprising:
an antenna coil configured to transmit and receive a magnetic induction signal;
a magnetic induction wireless communication circuit configured to wirelessly communicate the magnetic induction signal by using magnetic induction;
an electrode for a human body; and
a switching device configured to connect or disconnect a communication between the magnetic induction wireless communication circuit and the electrode for the human body,
wherein when the switching device connects the magnetic induction wireless communication circuit with the electrode for the human body, the magnetic induction signal is transmitted from the magnetic induction wireless communication circuit to the human body via the electrode for the human body, and
wherein a carrier frequency of the magnetic induction signal transmitted to the human body is equal to a carrier frequency of the magnetic induction signal propagating in the magnetic induction wireless communication circuit.

10. The communication apparatus as claimed in claim 9, wherein the switching device performs selective switchover between a connection of the magnetic induction wireless communication circuit with the antenna coil and a connection of the magnetic induction wireless communication circuit with the electrode for the human body.

11. The communication apparatus as claimed in claim 9,
wherein the switching device turns on or off a connection between the magnetic induction wireless communication circuit with the antenna coil and the electrode for the human body.

12. The intra-body communication apparatus as claimed in claim 1,
wherein the carrier frequency is 13.56 MHz.

13. The communication apparatus as claimed in claim 9,
wherein the carrier frequency is 13.56 MHz.

14. A communication method using a human body, comprising steps of:
receiving a magnetic induction signal from communication equipment at an antenna coil, the magnetic induction signal being carried by a wave having a carrier frequency;
transmitting the received magnetic induction signal via a resonance circuit including the antenna coil to an electrode for a human body and then to the human body,
wherein the resonance circuit resonates at the carrier frequency, and
wherein the received magnetic induction signal is transmitted at the carrier frequency, and a frequency of the magnetic induction signal is not converted or changed from the antenna coil to the electrode for a human body.
